(19) United States
(12) Patent Application Publication
(10) Pub. No.: US 2013/0310998 A1
(43) Pub. Date: Nov. 21, 2013

(54) ENERGY MANAGEMENT SYSTEM

(71) Applicants: Neel Banerjee, Corvallis, OR (US); Andreas H. Queisser, Corvallis, OR (US); Paul E. Watts, Corvallis, OR (US)

(72) Inventors: Neel Banerjee, Corvallis, OR (US); Andreas H. Queisser, Corvallis, OR (US); Paul E. Watts, Corvallis, OR (US)

(21) Appl. No.: 13/475,529

(22) Filed: May 18, 2012

(51) Int. Cl. G06F 1/26

(52) U.S. Cl. 700/295

(57) ABSTRACT

A measurement node is disclosed herein. An example of the measurement node includes a sensor to measure a parameter and a control module to govern operation of the sensor. The measurement node also includes a rechargeable power source to deliver energy to at least the sensor or the control module and an energy management system to regulate execution of tasks relating to the sensor to minimize total energy consumed from the rechargeable power source. An energy management system and a method for managing energy usage are also disclosed herein.

### BACKGROUND

Many different sources of energy exist including, for example, solar, wind, hydro, and mechanical, thermal, geo-thermal. These so-called “clean” or “green” sources of energy can be utilized to replace some of the energy derived from so-called “dirty” sources such as coal and gas. Some of these sources can also be used in more remote locations where electricity from a power distribution system is not readily available.

### BRIEF DESCRIPTION OF THE DRAWINGS

The following detailed description references the drawings, wherein:

FIG. 1 is an example of a measurement node.

FIG. 2 is an example of an energy collection profile.

FIG. 3 is an example of an energy management system.

FIG. 4 is an example of a method for managing energy usage.

### DETAILED DESCRIPTION

Efficient use of energy resources is desirable. This is particularly true in situations where the energy is supplied by a rechargeable power source. These rechargeable power sources can include components such as a rechargeable battery and an energy collection or harvesting source. The energy collection or harvesting source can include items such as a wind turbine, thermoelectric source, piezo-electric source, or one or more solar panels. The amount of energy that can be delivered by such rechargeable power sources can vary widely and depend on a variety of factors such as, for example, wind speed, time of day, temperature, barometric pressure, the season, altitude, temperature differential, mechanical movement, etc.

An additional factor to consider involves the scheduling of one or more tasks that consume energy from such rechargeable power sources. Some of the factors to consider regarding such scheduling include the available total energy level, the energy required for the tasks, the availability of additional energy via one or more energy collection sources, the periodicity or repeatability of such tasks, the addition of new tasks, the priority of a particular task relative to other tasks, and whether one or more of such tasks can be delayed or cancelled.

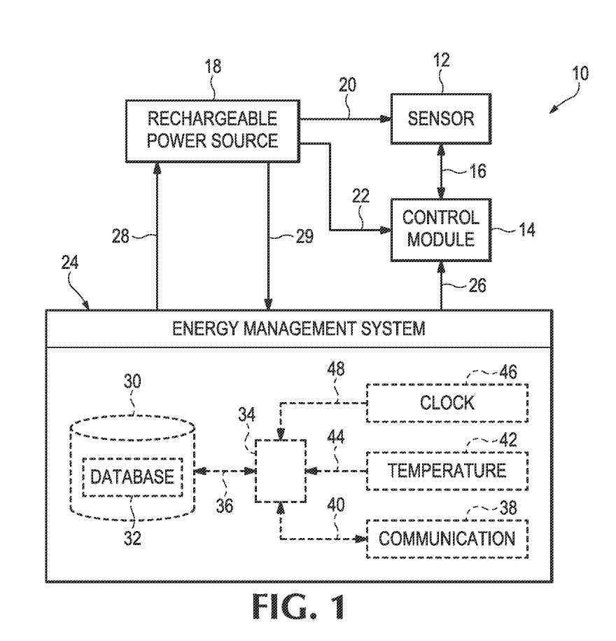

Intelligently queuing such tasks and having them occur during periods where the energy gathered from one or more energy collection sources is at its peak helps conserve the total energy consumed from the rechargeable power source. This allows the rechargeable power source to be used for other tasks when energy via the collection sources is reduced and/or unavailable. An example of a measurement node 10 designed with these objectives in mind is shown in FIG. 1.

As used herein, the terms “non-transitory storage medium” and non-transitory computer-readable storage medium” are defined as including, but not necessarily being limited to, any media that can contain, store, or maintain programs, information, and data. Non-transitory storage medium and non-transitory computer-readable storage medium may include any one of many physical media such as, for example, electronic, magnetic, optical, electromagnetic, or semiconductor media. More specific examples of suitable non-transitory storage medium and non-transitory computer-readable storage medium include, but are not limited to, a magnetic computer diskette such as floppy diskettes or hard drives, magnetic tape, a random access memory (RAM), a read-only memory (ROM), an erasable programmable read-only memory (EPROM), a flash drive, a compact disc (CD), or a digital video disk (DVD).

As used herein, the term “processor” or “control module” is defined as including, but not necessarily being limited to, an instruction execution system such as a computer/processor based system, an Application Specific Integrated Circuit (ASIC), or a hardware and/or software system that can fetch or obtain the logic from a non-transitory storage medium or a non-transitory computer-readable storage medium and execute the instructions contained therein. “Processor” can also include any controller, state-machine, microprocessor, cloud-based utility, service or feature, or any other analogue, digital and/or mechanical implementation thereof.

As used herein, the term “rechargeable power source” is defined as including, but not necessarily being limited to, a rechargeable battery and an energy collection or harvesting source such as a wind turbine, hydro-electric turbine, geo-thermal supply, thermoelectric source, piezo-electric source, one or more solar panels, etc. As used herein, the term “energy harvesting source” may be used interchangeably with the term “energy collection source.” As used herein, the term “task” or “tasks” is defined as including, but not necessarily being limited to a: function, process, operation, measurement, or other work. As used herein, the term “power” is defined as the usage or delivery of energy over a period of time.

As can be seen in FIG. 1, measurement node 10 includes a sensor 12 to measure a parameter. Sensor 12 can be any type of device depending upon the particular application and/or parameter to be measured. For example, sensor 12 can be a seismic sensor used in oil and gas exploration. In another example, sensor 12 can be a load cell used to measure weight. As yet another example, sensor 12 can be a thermistor used to measure temperature.

As can also be seen in FIG. 1, measurement node 10 additionally includes a control module 14 to govern operation of sensor 12, as indicated by double-headed arrow 16, as well as a rechargeable power source 18 to deliver energy to sensor 12, as indicated by arrow 20, and control module 14, as indicated by arrow 22. Measurement node 10 further includes an energy management system 24 to regulate execution of tasks relating to sensor 12 and control module 14, as indicated by arrow 26, to help conserve energy consumed from rechargeable power source 18, as indicated by arrow 28. Rechargeable power source 18 also delivers energy to the energy management system 24, as indicated by arrow 29.

As can be further seen in FIG. 1, the example of energy management system 24 includes a non-transitory storage medium 30 that has a database 32 that includes a queue. Energy management system 24 also includes a processor or control module 34 coupled to non-transitory storage medium 30 to receive instructions and data therefrom and to record data and instructions thereto, as indicated by double-headed arrow 36. Non-transitory storage medium 30 includes instructions that, when executed by processor 34, cause processor 34 to determine a number of periods (P_{N}) for which a total energy (E_{T}) is sufficient for a sequence of periodic tasks (E_{SPT}) and to retrieve a new task (T_{N}) from the queue of database 32.

Non-transitory storage medium 30 includes additional instructions that, when executed by processor 34, cause processor 34 to determine whether the number of periods (P_{N}) exceeds a threshold for a needed runtime (R_{T}) for the new task (T_{N}) and to execute the new task (T_{N}) when the number of periods (P_{N}) exceeds the threshold for the needed runtime (R_{T}) for the new task (T_{N}). Non-transitory storage medium 30 includes further instructions that, when executed by processor 34, cause processor 34 to determine whether the new task (T_{N}) is delayable when the number of periods (P_{N}) is less than the threshold for the needed runtime (R_{T}) for the new task (T_{N}) and to determine whether the new task (T_{N}) is cancellable when the number of periods (P_{N}) is less than the threshold for the needed runtime (R_{T}) for the new task (T_{N}).

An example of how the number of periods (P_{N}) may be determined where rechargeable power source 18 includes a rechargeable battery and an energy collection source follows.
1. Determine an Energy Total (E_{T}) of measurement node 10 which is equal to the sum of the Energy in the Rechargeable Battery (E_{B}) and the Energy in the Collection Source (E_{S}), E_{T}=E_{B}+E_{S}
2. Let E_{SPT}=the Energy needed for a Single Sequence of Periodic Tasks
3. Let E_{T}−(E_{SPT}×Number of Periods the Sequence of Periodic Tasks Need to Run (P_{N}))=0 (set equal to zero for the situation where all the energy in measurement node 10 is used)
4. This yields, E_{T}=(E_{SPT}×P_{N})
5. Solving for P_{N}, P_{N}=E_{T}/E_{SPT}

As can additionally be seen in FIG. 1, energy management system 24 may include a communications module 38 coupled to control module or processor 34 as indicated by double-headed arrow 40. Communications module 38 allows data to be transmitted (wirelessly or wired) from measurement node 10 to one or more remote sites (not shown in FIG. 1). This data can include things such as the status of measurement node 10, one or more measured parameters (e.g., available energy in rechargeable power source 18), etc. Communications module 38 also allows data to be received (wirelessly or wired) by measurement node 10 from the one or more remote sites. This data can include things such as one or more new tasks, an update or change to the instructions on non-volatile storage medium 30, weather forecasts, etc.

Energy management system 24 may also include a temperature sensor 42 coupled to control module or processor 34 as indicated by arrow 44. Data from temperature sensor 42 may, for example, be utilized by processor 34 in determining the energy available from rechargeable power source 18. As another example, data from temperature sensor 42 may alternatively or additionally be transmitted by communications module 38 to one or more remote sites. Energy management system 24 may additionally include a clock 46 coupled to control module or processor 34, as indicated by arrow 48. In this example, data from clock 46 is utilized by processor or control module 34 in scheduling of one or more tasks.

Non-transitory storage medium 30 may include further instructions that, when executed by processor 34, cause processor 34 to reschedule the new task (T_{N}) within the queue of the database when the new task (T_{N}) is delayable. Alternatively or additionally, non-transitory storage medium 30 may also include further instructions that, when executed by processor 34, cause processor 34 to remove the new task (T_{N}) from the queue of the database 32 when the new task (T_{N}) is cancellable.

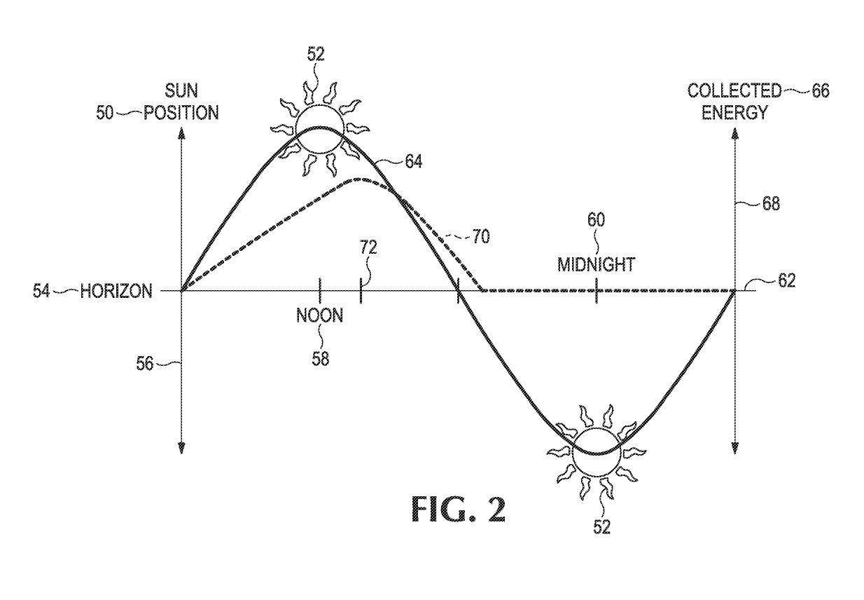

An example of an energy collection profile that illustrates the benefit of actively managing energy usage via an energy management system like that used, for example, in measurement node 10 is illustrated in FIG. 2. In this example, the rechargeable power source includes a rechargeable battery and an array of one or more solar panels (neither of which are shown in FIG. 2).

As can be seen in FIG. 2, the position 50 of the sun 52 with respect to the horizon 54 is plotted on vertical axis 56 versus various times in a day, such as noon 58 and midnight 60, which are plotted along horizontal axis 62. Curve 64 represents the resulting graph of this plot. The collected energy 66 versus various times in the day is plotted on vertical axis 68. Curve 70 represents the resulting graph of this plot. This collected energy represented by curve 70 can be used by the energy management system to recharge the power source (in this example a rechargeable battery).

As can also be seen in FIG. 2, this collected energy represented by curve 70 fluctuates with the time of day, in this example, reaching a maximum in the afternoon 72 and a minimum (i.e., zero) well before midnight 60. As can additionally be seen in FIG. 2, collected energy curve 70 lags sun position curve 64 due to factors such as the length of time it takes sun 52 to climb up over the horizon. The collected energy represented by curve 70 may also fluctuate due to weather conditions such as clouds. It can also fluctuate due to different positions of sun relative to the solar panels throughout the year.

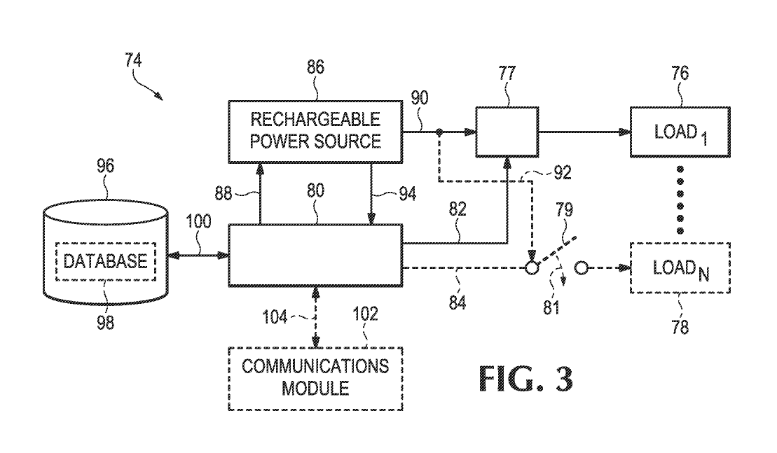

An example of an energy management system 74 is shown in FIG. 3. As can be seen in FIG. 3, energy management system 74 provides power to multiple loads, as represented by load₁ 76 through load_{N} 78. Load₁ 76 through load_{N} 78 can be the same or different devices. Load₁ 76 through load_{N} 78 can also be any type of device depending upon the particular application and/or parameter to be measured. For example, load₁ 76 may be a sensor of the type discussed above with respect to sensor 12 and load_{N} 78 may be a transducer. As another example, load₁ 76 may be a motor and load_{N} 78 may be a sensor. As a further example, load₁ 76 may be pump and load_{N} 78 may be a light. As yet a further example, load₁ 76 may be an industrial customer of a power distribution system and load_{N} 78 may be a consumer customer of a power distribution system.

As can also be seen in FIG. 3, energy management system 74 includes a processor 80 to govern operation of loads 76 through 78, as respectively indicated by arrow 82 and dashed arrow 84, as well as rechargeable power source 86, as indicated by arrow 88. Rechargeable power source 86 delivers energy to loads 76 through 78, as respectively indicated by arrow 90 and dashed arrow 92. Rechargeable power source 86 also delivers energy to processor 80, as indicated by arrow 94.

As can further be seen in FIG. 3, this example of energy management system 74 includes a non-transitory storage medium 96 that has a database 98 that includes a queue. Processor 80 is coupled to non-transitory storage medium 96 to receive instructions and other data therefrom and to store data and instructions thereon, as indicated by double-headed arrow 100. Non-transitory storage medium 96 includes instructions that, when executed by processor 80, cause processor 80 to determine a number of periods (P_{N}) for which a total energy (E_{T}) is sufficient for a sequence of periodic tasks (E_{SPT}) and to retrieve a new task (T_{N}) from the queue of database 98.

Non-transitory storage medium 96 includes additional instructions that, when executed by processor 80, cause processor 80 to determine whether the number of periods (P_{N}) exceeds a threshold for a needed runtime (R_{T}) for the new task (T_{N}) and to execute the new task (T_{N}) when the number of periods (P_{N}) exceeds the threshold for the needed runtime (R_{T}) for the new task (T_{N}). For example, when the new task (T_{N}) is determined to be executable and relates to supplying energy to load₁ 76, processor 80 actuates electrical module 77 (e.g., a logic circuit) which connects rechargeable power source 86 to load₁ 76. As another example, when another new task (T_{N}) is determined to be executable and relates to supplying energy to load_{N} 78, processor 80 closes switch or relay 79, as indicated by arrow 81, which connects rechargeable power source 86 to load_{N} 78.

Non-transitory storage medium 96 includes further instructions that, when executed by processor 80, cause processor 80 to determine whether the new task (T_{N}) is delayable when the number of periods (P_{N}) is less than the threshold for the needed runtime (R_{T}) for the new task (T_{N}) and to determine whether the new task (T_{N}) is cancellable when the number of periods (P_{N}) is less than the threshold for the needed runtime (R_{T}) for the new task (T_{N}). When rechargeable power source 86 includes a rechargeable battery and an energy collection source, the number of periods (P_{N}) may be determined in the same manner as described above in connection with measurement node 10.

As can additionally be seen in FIG. 3, energy management system 74 may include a communications module 102 coupled to processor 80 as indicated by double-headed arrow 104.

Communications module 102 allows data to be transmitted (wirelessly or wired) from energy management system 74 to one or more remote sites (not shown in FIG. 3). This data can include things such as the status of energy management system 74, one or more measured parameters (e.g., available energy in rechargeable power source 86), etc. Communications module 102 also allows data to be received (wirelessly or wired) by energy measurement system 74 from the one or more remote sites. This data can include things such as one or more new tasks, an update or change to the instructions on non-volatile storage medium 96, weather forecasts, etc.

Non-transitory storage medium 96 may include further instructions that, when executed by processor 80, cause processor 80 to reschedule the new task (T_{N}) within the queue of the database when the new task (T_{N}) is delayable. Alternatively or additionally, non-transitory storage medium 96 may also include further instructions that, when executed by processor 80, cause processor 80 to remove the new task (T_{N}) from the queue of database 98 when the new task (T_{N}) is cancellable.

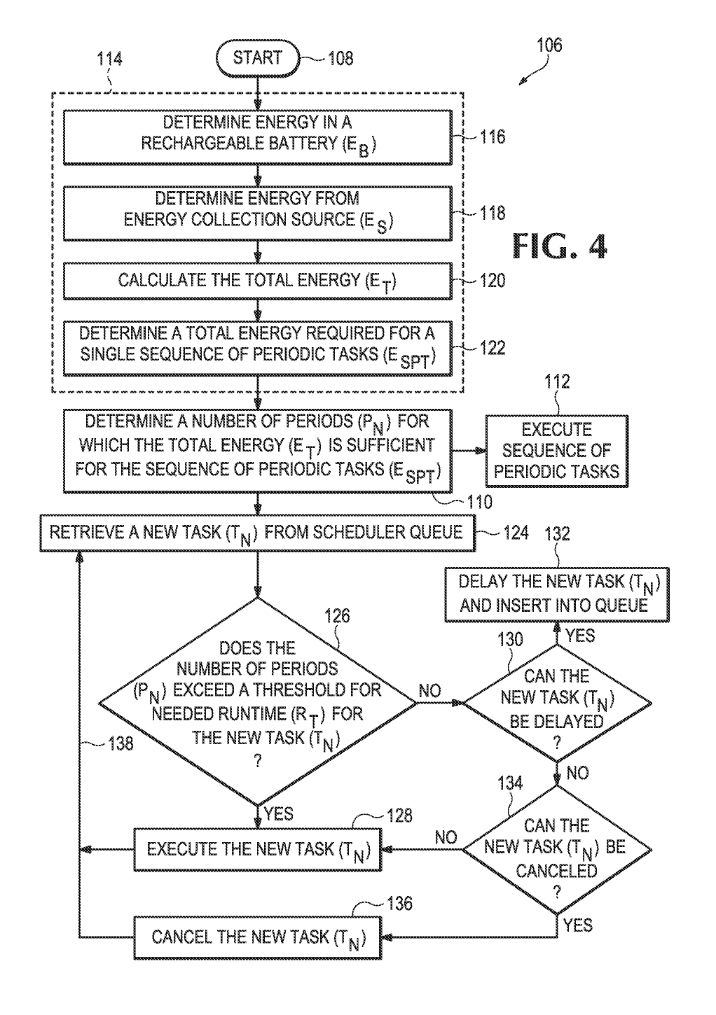

An example of a method for managing energy usage 106 is shown in FIG. 4. This method may be used with measurement node 10 and/or energy management system 74. It may also be used in other applications and with other systems. As can be seen in FIG. 4, method 106 starts 108 by determining a number of periods (P_{N}) for which a total energy (E_{T}) is sufficient for a sequence of periodic tasks (E_{SPT}), as indicated by block 110 and executing the sequence of those periodic tasks, as indicated by block 112.

Dashed block 114 in FIG. 4 illustrates an example of how the number of periods (P_{N}) may be determined where a rechargeable battery and energy collection source are utilized. First the energy in the rechargeable battery (E_{B}) is determined, as indicated by block 116, as well as the energy from the energy collection source (E_{S}), as indicated by block 118. Next, a total energy (E_{T}) is calculated, as indicated by block 120, which based on the determined energy in the rechargeable battery (E_{B}) and the determined energy from the energy collection source (E_{S}). Then, a total energy required for a single sequence of periodic tasks (E_{SPT}) is determined, as indicated by block 122. If one lets E_{T}−(E_{SPT}×the Number of Periods the Sequence of Periodic Tasks Need to Run (P_{N}))=0, so that all the energy is used, then E_{T}=(E_{SPT}×P_{N}). This yields P_{N}=E_{T}/E_{SPT}.

Next method 106 continues by retrieving a new task (T_{N}) from a scheduler queue of a database, as indicated by block 124, and determining whether the number of periods (P_{N}) exceeds a threshold for a needed runtime (R_{T}) for the new task (T_{N}), as indicated by block 126. If yes, then the new task (T_{N}) is executed, as indicated by block 128. If no, then method 106 determines whether the new task (T_{N}) is delayable, as indicated by block 130. If the new task (T_{N}) can be delayed, then method 106 reschedules the new task (T_{N}) within the queue of the database, as indicated by block 132. If the new task (T_{N}) is not delayable, then method 106 determines whether the new task (T_{N}) is cancellable, as indicated by block 134. If yes, then the new task (T_{N}) is removed from the queue of the database, as indicated by block 136. If not, then the new task (T_{N}) is executed, as indicated by block 128. As shown by arrow 138, method 106 then retrieves another new task (T_{N}) from the queue of the database, as indicated by block 124. Method 106 then determines P_{N} and R_{T} again and continues to block 126, as discussed above.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A measurement node, comprising:
a sensor to measure a parameter;
a control module to govern operation of the sensor;
a rechargeable power source to deliver energy to at least one of the sensor and the control module; and
an energy management system to regulate execution of tasks relating to the sensor to help conserve energy consumed from the rechargeable power source.

2. The measurement node of claim 1, further comprising a communications module coupled to the control module.

3. The measurement node of claim 1, wherein the energy management system includes:
a database including a queue;
a processor, and
a non-transitory storage medium including instructions that, when executed by the processor, cause the processor to:
determine a number of periods (P_{N}) for which a total energy (E_{T}) is sufficient for a sequence of periodic tasks,
retrieve a new task (T_{N}) from the queue of the database,
determine whether the number of periods (P_{N}) exceeds a threshold for a needed runtime (R_{T}) for the new task (T_{N}),
execute the new task (T_{N}) when the number of periods (P_{N}) exceeds the threshold for the needed runtime (R_{T}) for the new task (T_{N}),
determine whether the new task (T_{N}) is delayable when the number of periods (P_{N}) is less than the threshold for the needed runtime (R_{T}) for the new task (T_{N}), and
determine whether the new task (T_{N}) is cancellable when the number of periods (P_{N}) is less than the threshold for the needed runtime (R_{T}) for the new task (T_{N}).

4. The measurement node of claim 3, wherein the non-transitory storage medium includes further instructions that, when executed by the processor, cause the processor to determine an energy in a rechargeable battery (E_{B}), determine an energy from an energy collection source (E_{S}), and calculate a total energy (E_{T}) based on the determined energy in the rechargeable battery (E_{B}) and the determined energy from the energy collection source (E_{S}).

5. The measurement node of claim 4, wherein the non-transitory storage medium includes further instructions that, when executed by the processor, cause the processor to determine a total energy required for a single sequence of periodic tasks (E_{SPT}) and determine a number of periods (P_{N}) for which the total energy (E_{T}) is sufficient for the sequence of periodic tasks (E_{SPT}).

6. The measurement node of claim 3, wherein the non-transitory storage medium includes further instructions that, when executed by the processor, cause the processor to reschedule the new task (T_{N}) within the queue of the database when the new task (T_{N}) is delayable.

7. The measurement node of claim 3, wherein the non-transitory storage medium includes further instructions that, when executed by the processor, cause the processor to remove the new task (T_{N}) from the queue of the database when the new task (T_{N}) is cancellable.

8. An energy management system, comprising:
a rechargeable power source;
a database including a queue;
a processor, and
a non-transitory storage medium including instructions that, when executed by the processor, cause the processor to:
determine a number of periods (P_{N}) for which a total energy (E_{T}) is sufficient for a sequence of periodic tasks,
retrieve a new task (T_{N}) from the queue of the database,
determine whether the number of periods (P_{N}) exceeds a threshold for a needed runtime (R_{T}) for the new task (T_{N}),
execute the new task (T_{N}) when the number of periods (P_{N}) exceeds the threshold for the needed runtime (R_{T}) for the new task (T_{N}),
determine whether the new task (T_{N}) is delayable when the number of periods (P_{N}) is less than the threshold for the needed runtime (R_{T}) for the new task (T_{N}), and
determine whether the new task (T_{N}) is cancellable when the number of periods (P_{N}) is less than the threshold for the needed runtime (R_{T}) for the new task (T_{N}).

9. The energy management system of claim 8, wherein the non-transitory storage medium includes further instructions that, when executed by the processor, cause the processor to reschedule the new task (T_{N}) within the queue of the database when the new task (T_{N}) is delayable.

10. The energy management system of claim 8, wherein the non-transitory storage medium includes further instructions that, when executed by the processor, cause the processor to remove the new task (T_{N}) from the queue of the database when the new task (T_{N}) is cancellable.

11. The energy management system of claim 8, further comprising a communications module coupled to the processor.

12. The energy management system of claim 8, wherein the non-transitory storage medium includes further instructions that, when executed by the processor, cause the processor to determine an energy in a rechargeable battery (E_{B}), determine an energy from an energy collection source (E_{S}), and calculate a total energy (E_{T}) based on the determined energy in the rechargeable battery (E_{B}) and the determined energy from the energy collection source (E_{S}).

13. The energy management system of claim 12, wherein the non-transitory storage medium includes further instructions that, when executed by the processor, cause the processor to determine a total energy required for a single sequence of periodic tasks (E_{SPT}) and determine a number of periods (P_{N}) for which the total energy (E_{T}) is sufficient for the sequence of periodic tasks (E_{SPT}).

14. A method for managing energy usage, comprising:
determining a number of periods (P_{N}) for which a total energy (E_{T}) is sufficient for a sequence of periodic tasks;
retrieving a new task (T_{N}) from a queue of a database;
determining whether the number of periods (P_{N}) exceeds a threshold for a needed runtime (R_{T}) for the new task (T_{N});
executing the new task (T_{N}) when the number of periods (P_{N}) exceeds the threshold for the needed runtime (R_{T}) for the new task (T_{N});
determining whether the new task (T_{N}) is delayable when the number of periods (P_{N}) is less than the threshold for the needed runtime (R_{T}) for the new task (T_{N}); and
determining whether the new task (T_{N}) is cancellable when the number of periods (P_{N}) is less than the threshold for the needed runtime (R_{T}) for the new task (T_{N}).

15. The method of claim 14, further comprising rescheduling the new task (T_{N}) within the queue of the database when the new task (T_{N}) is delayable.

16. The method of claim 14, further comprising removing the new task (T_{N}) from the queue of the database when the new task (T_{N}) is cancellable.

17. The method of claim 14, further comprising:
determining an energy in a rechargeable power battery (E_{B});
determining an energy from an energy collection source (E_{S}); and
calculating a total energy (E_{T}) based on the determined energy in the rechargeable battery (E_{B}) and the determined energy from the energy collection source (E_{S}).

18. The method of claim 17, further comprising determining a total energy required for a single sequence of periodic tasks (E_{SPT}).

19. The method of claim 14, further comprising receiving data via a communications module.

20. The method of claim 14, further comprising transmitting data via a communications module.
